(19) United States
(12) Patent Application Publication
(10) Pub. No.: US 2025/0260049 A1
(43) Pub. Date: Aug. 14, 2025

(54) FLUORINATED SULFONAMIDE COMPOUNDS FOR ENHANCING ION CONDUCTIVITY OF POLYMER ELECTROLYTES

(71) Applicant: Toyota Motor Engineering & Manufacturing North America, Inc., Plano, TX (US)

(72) Inventors: Chuhong Wang, Ann Arbor, MI (US); Siwen Wang, Livonia, MI (US); Chen Ling, Troy, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/441,817

(22) Filed: Feb. 14, 2024

(51) Int. Cl. H01M 10/0565; H01M 10/0525

(52) U.S. Cl. CPC H01M 10/0565; H01M 10/0525; H01M 2300/0082

(57) ABSTRACT

Disclosed herein are compositions and methods for enhancing the ionic conductivity of a solid polymer electrolyte which comprise incorporating an additive that comprises at least one fluorinated sulfonamide compound selected from the group consisting of formulae (1) to (5) into the polymer matrix:

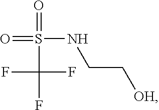 [SMILES: O=S(=O)(NCCO)C(F)(F)F]

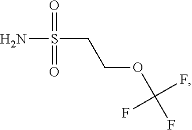 [SMILES: NS(=O)(=O)CCOC(F)(F)F]

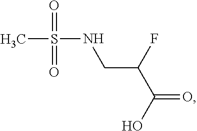

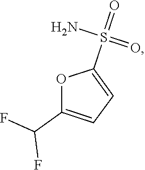 [SMILES: NS(=O)(=O)c1ccc(C(F)F)o1]

and

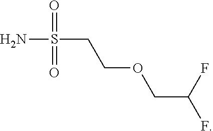 [SMILES: NS(=O)(=O)CCOCC(F)F]

### TECHNICAL FIELD

The present disclosure generally relates to polymer electrolytes for electrochemical devices, and more particularly solid polymer electrolytes that comprise fluorinated sulfonamide ionic conduction enhancing additives, wherein the solid polymer electrolyte achieves a high ionic conduction rate, and desirable mechanical and electrochemical properties.

### BACKGROUND

Lithium-ion (Li-ion) batteries are the most popular type of energy storage system and are used in various types of devices such as electric vehicles (EV), consumer electronics, and grid energy storage. Li-ion batteries can use a variety of electrolytes including liquid, solid, and gel electrolytes.

Among the electrolytes currently employed in Li-ion batteries, liquid electrolytes, while widely utilized, suffer from issues such as low thermal stability, volatility, and the potential for leakage. Solid-state batteries comprising a solid polymer electrolyte (SPE) are generally considered to be safer than liquid electrolytes because they exhibit low volatility, but they exhibit low ionic conductivity and are prone to allow the growth and proliferation of lithium dendrites which can lead to short circuiting of batteries.

Solid polymer electrolytes are classified as organic polymer electrolytes or inorganic polymer electrolytes. Inorganic polymer electrolytes such as ceramic solid electrolytes possess excellent stability and safety but are often limited by their poor interfacial contact and high resistance, leading to reduced or low ionic conductivity.

Polyethylene oxide based (PEO-based) polymer electrolytes, which are commonly employed solid organic polymer electrolytes, exhibit improved safety, flexural strength, and processability compared to liquid and ceramic alternatives, but they suffer from low to moderate ionic conductivity at room temperature (i.e., <10⁻⁴ S cm⁻¹) and low Li⁺ transference number (less than 0.5), limiting their application in high-performance devices. Gel polymer electrolytes include a plasticizer, such as liquid or plastic crystal plasticizers, to enhance ionic conduction. However, gel polymers have low oxidation with high polarity and are not suitable for use with lithium metal oxide cathode materials which are regularly charged at ≥4.2 V vs Li/Li⁺.

Thus, it is desirable to develop solid polymer electrolytes that have high ionic conductivity, electrochemical stability, good mechanical strength, and flexibility, and which maintain their solid state good cyclability, and low cost and scalability, which enables their widespread use in energy storage devices and other electrochemical systems.

### SUMMARY

This section provides a general summary of the disclosure and is not a comprehensive disclosure of its full scope or all of its features.

In various aspects, the present teachings provide a composition for a solid polymer electrolyte which comprises an ion-conducting polymer matrix; a lithium salt; and an additive comprising at least one fluorinated sulfonamide compound selected from the group consisting of:

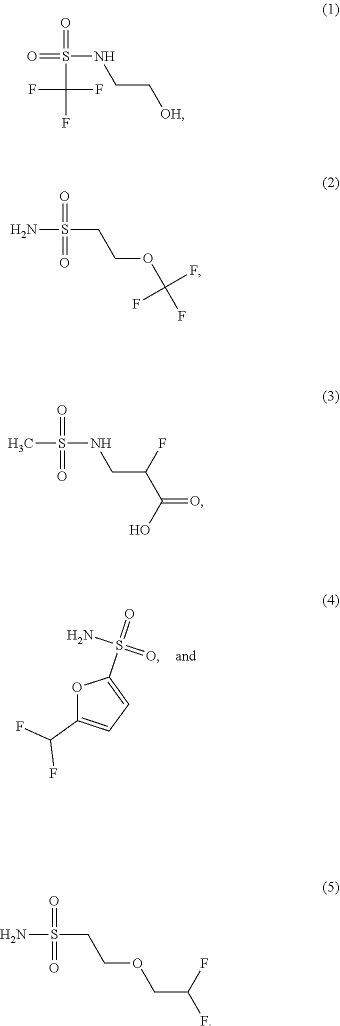

In one aspect, the ion-conducting polymer matrix may comprise a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC).

In another aspect, the ion-conducting polymer matrix comprises a charge-transfer complex which comprises a polar aromatic ring. The charge-transfer complex may comprise a polyphenylene sulfide (PPS) matrix or a 6-dimethyl-p-phenylene sulfide (PMPS) matrix. The charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ). In some examples, the charge-transfer complex comprises combinations of an electron donor and an electron acceptor such as HQ-BQ, Th-BQ, Px-BQ, Py-TCNQ, TTF-TCNQ, TTF-CL, or Ph-CLA. In some examples, the lithium salt may be bis(trifluoromethanesulfonyl)imide (LiTFSI).

In at least one example, the solid polymer electrolyte comprises polyphenylene sulfide (PPS), tetrafluoro-1,4-benzoquinone (TFBQ), lithium bis (trifluoromethane sulphone) imide (LiTFSI), and at least one additive selected from the group consisting of formulae (1), (2), (3), (4), and (5).

The compositions of the present disclosure are used for solid polymer electrolytes, solid-state lithium-ion batteries, electrochemical systems, and the like. In one aspect, the solid-state lithium-ion battery comprises an anode; a cathode; a solid polymer electrolyte between the anode and cathode; an anode collector; and a cathode collector. The polymer electrolyte comprises: an ion-conducting polymer matrix; a lithium salt; and an additive comprising at least one fluorinated sulfonamide compound selected from the group consisting of formulae (1), (2), (3), (4), and (5):

The ion-conducting polymer matrix may comprise a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC). In some examples, the ion-conducting polymer comprises a charge-transfer complex.

In yet another aspect, the disclosure provides a method for enhancing ion conductivity of a solid polymer electrolyte, said method comprising: providing an ion-conducting polymer matrix and adding a lithium salt and an additive comprising at least one fluorinated sulfonamide compound selected from the group consisting of formulae (1), (2), (3), (4), and (5):

In some examples, the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), and polypropyl carbonate (PPC).

In other examples, the ion-conducting polymer matrix comprises a charge-transfer complex. The charge-transfer complex may comprise a polyphenylene sulfide (PPS) matrix or a 6-dimethyl-p-phenylene sulfide (PMPS) matrix. The charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ). In some examples, the charge-transfer complex comprises combinations of an electron donor and an electron donor selected from HQ-BQ, Th-BQ, Px-BQ, Py-TCNQ, TTF-TCNQ, TTF-CL, or Ph-CLA. In some examples, the lithium salt is bis(trifluoromethanesulfonyl)imide (LiTFSI). In at least one example, the charge conducting complex comprises polyphenylene sulfide (PPS) and an electron acceptor which comprises tetrafluoro-1,4-benzoquinone (TFBQ), and bis(trifluoromethanesulfonyl)imide (LiTFSI).

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF DRAWINGS

The present teachings will become more fully understood from the detailed description and the accompanying drawings wherein:

FIG. 1 is a schematic illustration of a Li-ion battery with a solid polymer electrolyte.

FIG. 2 is a graph showing the Li-ion diffusivities and viscosities of the fluorinated sulfonamide additive compounds for a solid polymer electrolyte of the present disclosure as predicted from atomistic molecular dynamic (MD) simulations compared to previously reported sulfonic molecule additives (represented by stars).

FIG. 3A is an illustration of the predicted solvation structures of the first Li+ solvation sheath from atomistic molecular dynamic (MD) simulations. The coordinating oxygen on solvents and anions are labeled.

FIG. 3B is an illustration of the distribution of different electrolyte systems, PPS/TFBQ/LiTFSI, PPS/TFBQ/Addi/LiTFSI as determined by atomistic molecular dynamic (MD) simulations.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides compositions and methods for enhancing the ionic conductivity of polymer electrolytes for electrochemical devices and a solid polymer electrolyte for an electrochemical device such as a lithium-ion battery that has enhanced ionic conductivity, efficiency, electrochemical properties, mechanical stability, and overall performance, and which retains safety and processability to enable broad application in electrochemical systems.

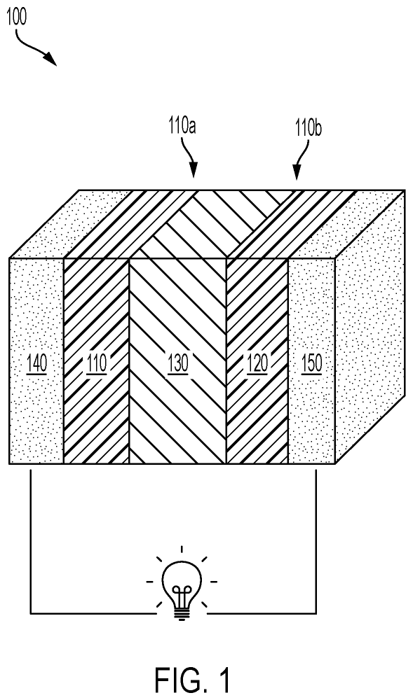

Lithium-ion (Li-ion) batteries are batteries in which lithium ions move from the negative electrode to the positive electrode during discharge and back to anode when charged. The terms “lithium-ion battery”, “LI-ion battery”, “lithium metal battery”, are used interchangeably herein throughout the disclosure unless otherwise specified. A “solid-state lithium-ion battery” refers to a lithium-ion battery that includes a solid polymer electrolyte as opposed to a liquid or gel polymer electrolyte. FIG. 1 illustrates a solid-state lithium-ion battery 100 which comprises an anode 110, a cathode 120, a solid polymer electrolyte 130 between the anode 110 and cathode 120, and anode and cathode current collectors 140 and 150, respectively. The cathode 120, or positive electrode, may be composed of lithium-containing compound such as a lithium metal oxide. Suitable lithium metal oxides include but are not limited to lithium cobalt oxide (LiCoO₂), lithium manganese oxide (LiMn₂O₄), and lithium iron phosphate (LiFePO₄). The anode 110 may be made of a carbon-based material such as graphite, silicon, or lithium metal in some designs. The solid polymer electrolyte 130 is positioned between and interfaces with both the anode 110 and cathode 120 at anodic interface 110(a) and cathodic interface 120(b) respectively. The solid polymer electrolyte 130 serves as the medium through which lithium ions move between the anode 110 and cathode 120 during electrochemical reactions. The anodic interface 110(a) and cathodic interface 120(b) facilitate transport of lithium ions during charge and discharge. Anodic and cathodic current collectors 140 and 150, respectively, conduct the electrical current that is generated during the flow of ions between electrodes.

The composition and methods of the present disclosure provide enhanced ionic conductivity of the polymer electrolyte, leading to an increase of up to 4 orders of magnitude in comparison to an additive-free polymer electrolyte. By incorporating at least one of the fluorinated sulfonamide compounds of formulae (1), (2), (3), (4), and (5) as additives to the polymer electrolyte, a high ionic conductivity of about 1 mS cm⁻¹ or greater at room temperature (e.g., 25° C.) of the polymer electrolyte. The solid polymer electrolyte 130 of the present disclosure comprises an ion-conducting polymer matrix, a lithium salt, and an additive comprising at least one fluorinated sulfonamide compound selected from 1,1,1-trifluoro-N-(2-hydroxyethyl)methanesulfonamide, represented by the following formula (1):

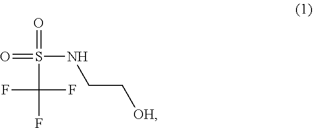 [SMILES: O=S(=O)(NCCO)C(F)(F)F]

2-(trifluoromethoxy)ethane-1-sulfonamide represented by the following formula (2):

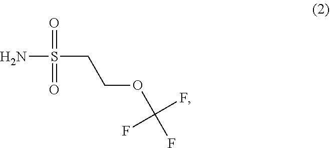 [SMILES: NS(=O)(=O)CCOC(F)(F)F]

2-fluoro-3-(methanesulfonamido)propanoic acid represented by the following formula (3):

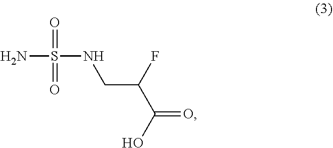 [SMILES: NS(=O)(=O)NCC(F)C(=O)O]

5-(difluoromethyl)furan-2-sulfonamide represented by the following formula (4):

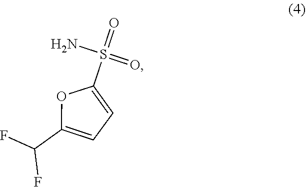 [SMILES: NS(=O)(=O)c1ccc(C(F)F)o1]

and 2-(2,2-difluoroethoxy)ethane-1-sulfonamide represented by the following formula (5):

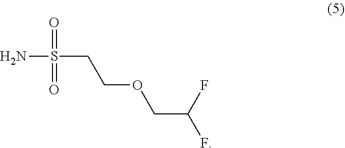 [SMILES: NS(=O)(=O)CCOCC(F)F]

In the present disclosure, “ion-conducting polymer matrix” refers to a polymer matrix capable of conducting ions. The ion-conducting polymer matrix serves as an electrolyte in an electrochemical device, such as a Li-ion battery. The ion-conducting polymer matrix may be selected for its ability to conduct lithium ions in combination with other desirable properties including, but not limited to electrochemical stability, mechanical flexibility or stability, thermal stability, low interfacial resistance, chemical stability, low cost and scalability, and ease of processing and manufacture.

The ion-conducting polymer matrix may be a polar polymer that facilitates the movement of ions between the anode and cathode. In some examples the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), polyethylene carbonate (PEC), and polypropyl carbonate (PPC).

A lithium salt is dissolved or dispersed within the polymer matrix to provide ionic conduction. Suitable lithium salts include but are not limited to bis(trifluoromethanesulfonyl)imide (LiTFSI⁻), lithium hexafluorophosphate (LiPF₆⁻), lithium hexafluoroarsenate (LiAsF₆⁻), lithium tetrafluoroborate (LiBF₄⁻), and lithium perchlorate (LiClO₄⁻). Lithium ions in a polymer matrix are dissociated from the counteranions and coordinate with the electron donor groups in the polymer matrix. Under the effect of an electric field the lithium ions hop from one coordinating site to another. In some examples of the present disclosure, the lithium salt is LiTFSI which has a higher thermal stability relative to LiPF₆, LiAsF₆, BF₄, and LiClO₄.

The present inventors discovered that the following small molecule fluorinated sulfonamide compounds of formula (1), (2), (3), (4), and (5) having a molecular weight of ≤200 g/mol significantly enhance the ionic conductivity of the solid-state polymer electrolyte when incorporated as an additive to the polymer matrix of a solid-state polymer electrolyte:

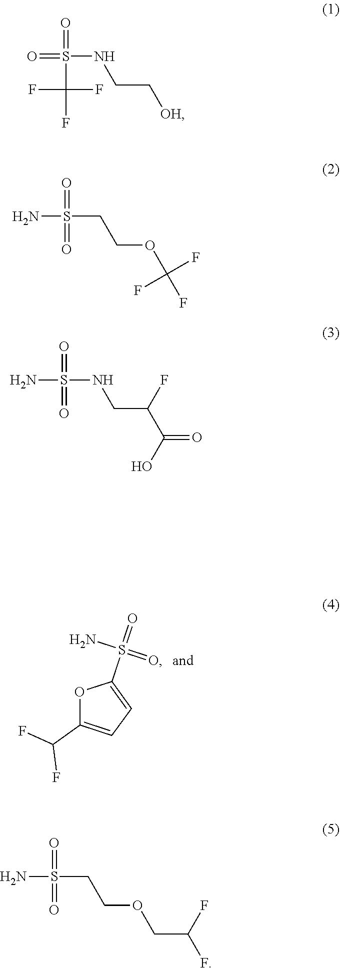 [SMILES: O=S(=O)(NCCO)C(F)(F)F ; NS(=O)(=O)CCOC(F)(F)F ; NS(=O)(=O)NCC(F)C(=O)O ; NS(=O)(=O)c1ccc(C(F)F)o1 ; NS(=O)(=O)CCOCC(F)F]

The fluorinated sulfonamide compounds employed in the present disclosure were identified through a high-throughput screening process designed and employed by the present inventors to identify ether carbonate-based (EC-based) compounds having desirable chemical and structural properties to meet criteria determined and established by the present inventors of both high lithium ion conductivity, and maintenance of a solid polymer physical state to be suitable as a solid-state electrolyte for a solid-state lithium-ion battery having improved ionic conductivity of an increase of up to 4 orders of magnitude compared to a PEO based polymer electrolyte.

Prior to the work of the present inventors, the fluorinated sulfonamide compounds of formulae (1), (2), (3), (4), and (5) of the present disclosure had been used in liquid electrolytes but had not been employed as additives for a solid-state polymer electrolyte. The fluorinated compounds of formulae (1), (2), (3), (4), and (5) had not been considered for use in a solid polymer electrolyte because the addition of many solvent molecules tends to lead to the transformation of the polymer electrolyte into a liquid or gel-like state, which is undesirable for a solid-state polymer electrolyte as in the present disclosure. However, through high throughput atomic simulations, the present inventors were able to identify the fluorinated sulfonamide compounds of formulae (1), (2), (3), (4), and (5) as additives for a solid polymer electrolyte that can enhance ionic conductivity without compromising the solid-state nature of the polymer electrolyte. Additionally, it was determined that the fluorinated sulfonamide additive compounds of formulae (1), (2), (3), (4), and (5) reduce the formation of anion aggregates in the solvation sheath of Li+ ions, consequently enhancing ionic conduction in the polymer electrolyte.

In some examples of the polymer electrolyte composition of the present disclosure, the ion-conducting polymer matrix comprises a charge-transfer complex. Charge-transfer complexes are characterized by their intermolecular partial electron transfer between electron donors and electron acceptors. The charge-transfer complex may include a polymer matrix which includes a polar aromatic ring. Some examples of the polymer matrix of the charge-transfer complex include, but are not limited to, a polyphenylene sulfide (PPS) matrix and a 6-dimethyl-p-phenylene sulfide (PMPS) matrix. In some examples, the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ). In some examples, the charge-transfer complex may comprise combinations of the electron donor and electron acceptor, including but not limited to: HQ-BQ, Th-BQ, Px-BQ, Py-TCNQ, TTF-TCNQ, TTF-CL, or Ph-CLA. In one example of the present disclosure, the composition for a solid polymer electrolyte comprises polyphenylene sulfide (PPS), tetrafluoro-1,4-benzoquinone (TFBQ), lithium bis(trifluoromethane sulphone) imide (LiTFSI), and at least one additive selected from the group consisting of:

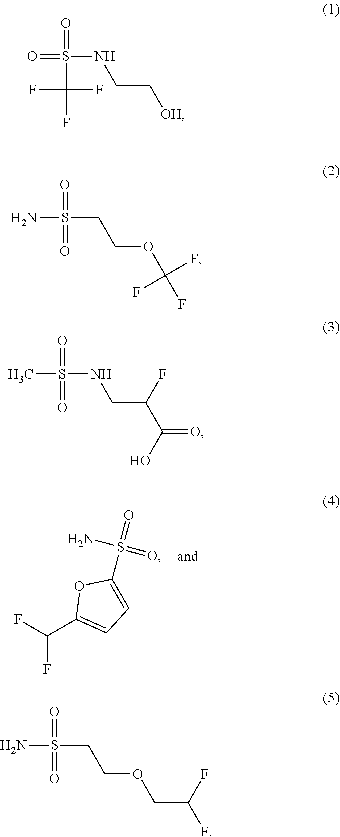

The polymer electrolyte of the present disclosure is composed of a mixture of the ion-conducting polymer matrix and lithium salt blended with at least one of the fluorinated sulfonamide compounds of formula (1), (2), (3), (4), and (5) of the present disclosure. The ion-conducting polymer matrix; lithium salt, and additive comprising at least one of the fluorinated sulfonamide compounds of formulas (1), (2), (3), (4), and (5) may be provided in a ratio of 56:14:30. The solid polymer electrolyte may be prepared by known solvent casting, hot molding, or extrusion techniques.

The present disclosure is also directed to a method for enhancing the ion conductivity of a solid polymer electrolyte. Liquid plasticizers, such as propylene carbonate and dimethyl carbonate, have been employed to enhance the ionic conductivity of polymer electrolytes, resulting in gel polymer electrolytes. Sulfones such as those represented in Table 1 have been considered as oxidatively stable solvents (up to 5.8 V vs Li/Li⁺) to replace carbonates in liquid Li-ion battery electrolytes. In contrast, the fluorinated sulfonamide compounds of the present disclosure are solid additives for a solid polymer electrolyte. By providing an ion-conducting polymer matrix, a lithium salt, and an additive comprising at least one fluorinated sulfonamide compound selected from the group consisting of:

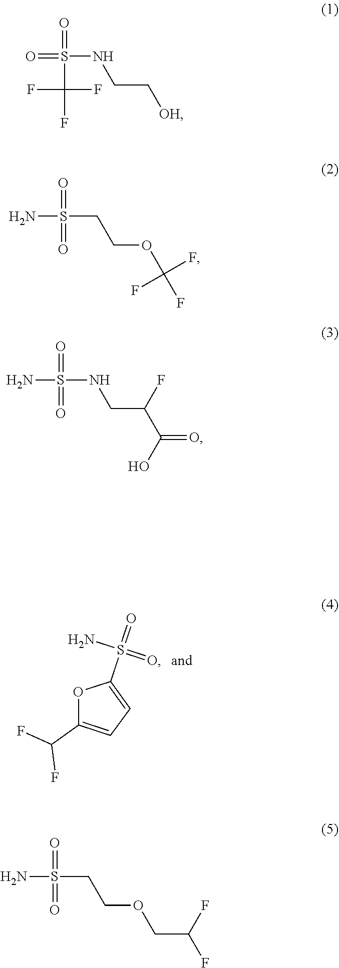 [SMILES: O=S(=O)(NCCO)C(F)(F)F ; NS(=O)(=O)CCOC(F)(F)F ; NS(=O)(=O)NCC(F)C(=O)O ; NS(=O)(=O)c1ccc(C(F)F)o1 ; NS(=O)(=O)CCOCC(F)F]

a solid polymer electrolyte having a high ionic conductivity of about 1 mS cm⁻¹ at 25° C. can be achieved.

In some examples of the present disclosure, the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), and polypropyl carbonate (PPC).

In other examples of the present disclosure, the ion-conducting polymer matrix comprises a charge-transfer complex. The charge-transfer complex may include a polymer matrix which includes a polar aromatic ring. Some examples of the polymer matrix of the charge-transfer complex include but are not limited to, a polyphenylene sulfide (PPS) matrix and a 6-dimethyl-p-phenylene sulfide (PMPS) matrix. In some examples, the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ). In some examples, the charge-transfer complex may comprise combinations of the electron donor and electron acceptor, including but not limited to: HQ-BQ, Th-BQ, Px-BQ, Py-TCNQ, TTF-TCNQ, TTF-CL, or Ph-CLA. In one example of the present disclosure, the composition for a solid polymer electrolyte comprises polyphenylene sulfide (PPS), tetrafluoro-1,4-benzoquinone (TFBQ), lithium bis(trifluoromethane sulphone) imide (LiTFSI), and at least one additive selected from the group consisting of formulae (1), (2), (3), (4), and (5) of the present disclosure.

The addition of the fluorinated sulfonamide compounds of the present disclosure to a solid polymer electrolyte significantly enhances the ionic conductivity of the solid polymer electrolytes to about 1 mS cm⁻¹ at room temperature. By improving the transport of lithium ions within the solid polymer electrolyte, the fluorinated sulfonamide additives of the present disclosure allow for faster charge and discharge rates in energy storage devices, leading to improved rate performance. In the examples where the ion-conducting polymer matrix of the solid polymer electrolyte comprises a charge-transfer complex, dissociated lithium ions move readily through the charge-transfer complex. The additive fluorinated sulfonamide compounds of the present disclosure specifically target the charge-transfer complex-based polymer electrolytes, enabling the retention of their desirable safety and processability characteristics while simultaneously improving their ionic conductivity.

In other examples, the polymer electrolyte of the present disclosure can be used in a solid-state lithium-ion battery. In some examples, the sold-state lithium-ion battery comprises an anode, a cathode, a solid polymer electrolyte between the anode and cathode, an anode collector; and a cathode collector. The polymer electrolyte comprises an ion-conducting polymer matrix; a lithium salt; and an additive comprising at least one fluorinated sulfonamide compound selected from the group consisting of:

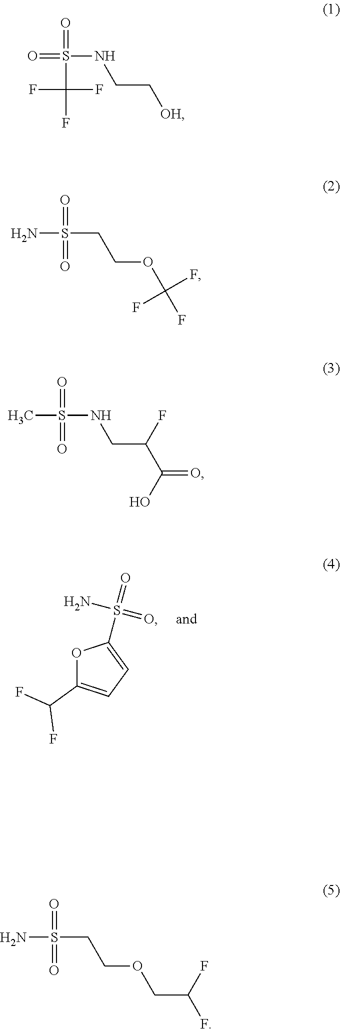

The polymer electrolyte of the present invention can be applicable to various electrochemical systems, such as electric vehicles, hybrid vehicles, and stationary energy storage systems, where high-rate performance is crucial for efficient energy utilization and improved overall device performance.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis of Ion-Conducting Polymer Matrix with Charge-transfer Complex (PPS+TFBQ)

PPS powder was jet-milled to create roughly spherical particles with a D50 of 15 μm. At room temperature, the white PPS powder was then mixed with a pale yellow TFBQ powder, which yielded a pale violet powder. The violet powder was then added to a vial, which was sealed and then slowly heated to 275° C. at 0.2° C. min⁻¹ and held there for 4 additional hours.

### Example 2. Li-ion Diffusivity and Viscosity

Atomistic molecular dynamic (MD) simulations were conducted to determine the predicted Li-ion diffusivity and viscosity of polymer electrolytes resulting from the incorporation of the fluorinated sulfonamide compounds of formula (1), (2), (3), (4), and (5).

Li⁺ diffusivities were evaluated through atomistic molecular dynamic (MD) simulations of polymer electrolyte comprising a charge-transfer (CT) complex comprising PPS and TFBQ, LiTFSI, and each of the additive fluorinated sulfonamide compounds of formula (1), (2), (3), (4), and (5) in Table 1. The diffusivities of lithium ions were calculated using the mean squared displacement (MSD) of the Li atoms following:

$$D = \frac{〈 {[ {x}_{i} ( t ) - {x}_{i} ( 0 ) ]}^{2} 〉}{6 t}$$

where x is the position of the particle, t is the simulation time, and <·> denotes an ensemble average over the particles.

The viscosity of each of the polymer mixture was calculated by Green-Kubo formulism:

$$η = \frac{V}{{k}_{B} T} {\int }_{0}^{∞} 〈 {P}_{α β} ( t ) \cdot {P}_{α β} ( 0 ) 〉 dt$$

where V is the system volume, kB is the Boltzmann constant, T is temperature, and P denotes the element of the pressure tensor.

The predicted values of Li-ion diffusivity and viscosity as determined by atomistic molecular dynamic (MD) simulations using the Simplified Molecular Input Line Entry System (SMILES) representation of the fluorinated sulfonamide compounds of formula (1), (2), (3), (4), and (5) are provided in Table 1.

TABLE 1

| | | | Li-ion | Vis- |
|---|---|---|---|---|
| Addi- | Structural | SMILES | diffusivity | cosity |
| tive | formula | representation | (cm²/s) | (Pa.s) |
| (1) | 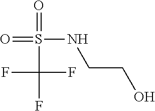 [SMILES: O=S(=O)(NCCO)C(F)(F)F] | O═S(═O)(NCCO)C(F)(F)F | 1.727 × 10⁻⁷ | 0.0074 |
| (2) | 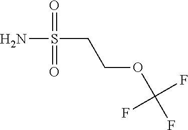 [SMILES: NS(=O)(=O)CCOC(F)(F)F] | NS(═O)(═O)CCOC(F)(F)F | 1.358 × 10⁻⁷ | 0.0074 |
| (3) | 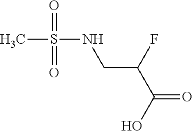 | CS(═O)(═O)NCC(F)C(═O)O | 1.188 × 10⁻⁷ | 0.0075 |
| (4) | 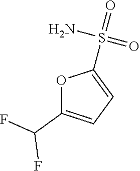 [SMILES: NS(=O)(=O)c1ccc(C(F)F)o1] | NS(═O)(═O)c1ccc(C(F)F)o1 | 0.786 × 10⁻⁷ | 0.0083 |
| (5) | 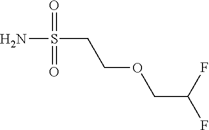 [SMILES: NS(=O)(=O)CCOCC(F)F] | NS(═O)(═O)CCOCC(F)F | 0.489 × 10⁻⁷ | 0.016 |

Diffusivity and viscosity relate to the mobility of the lithium ions, which influences the charge and discharge rate of the battery. Higher diffusivity allows for faster movement of the lithium ions within the electrodes and lower viscosity allows for the electrolyte to flow more easily for improved transportation of the ions. Generally, a higher Li+ diffusivity implies a higher Li+ conductivity. Thus, the data provided in Table 1 indicates that the addition of the additives containing at least one of the fluorinated sulfonamide compounds of formula (1), (2), (3), (4), and (5) significantly improves the rate capability of the polymer matrix and ion conduction. This suggests that the additives play a crucial role in facilitating ion transport and improving the overall conductivity of the polymer electrolyte.

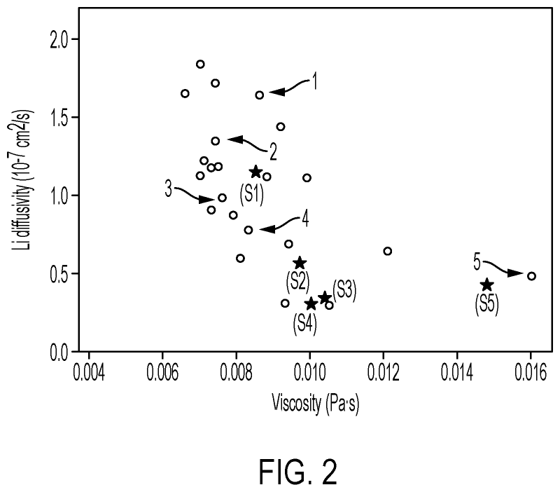

FIG. 2 shows a comparison of the fluorinated sulfonamide compounds of formulae (1) -(5) of the present disclosure to previously reported sulfonic compounds (S1), (S2), (S3), (S4), and (S5) which have been demonstrated as being functional in solid polymer electrolytes. These comparative sulfonic compounds are provided in Table 2 and are identified as black stars in FIG. 2.

TABLE 2

| | | | Li-ion |
|---|---|---|---|
| | | | diffusivity |
| Additive | Classification | Structure | (cm²/s) |
| (S1) Thietane- 1,1- dioxide (TT) | Sulfone | 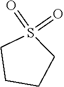 | 1.16 × 10⁻⁷ |
| (S2) Sulfolane (SL) | Sulfone | 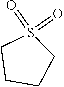 | 0.576 × 10⁻⁷ |
| (S3) 1,3-Propane sultone (PS) | Sulfone | 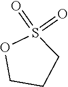 | 0.432 × 10⁻⁷ |
| (S4) (Dimethyl- sulfamoyl)- dimethylamine (DMSDMA) | Sulfonamide | 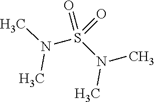 | 0.351 × 10⁻⁷ |
| (S5) 1,2-Ethylene sulfate (ES) | Sulfate | 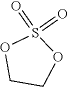 | 0.332 × 10⁻⁷ |

From FIG. 2, as compared to the sulfonic acid molecules, the fluorinated sulfonamide compounds of the present disclosure displayed remarkable properties of high diffusivity while maintaining moderate viscosity, which is essential for device stability.

### Example 3. Ionic Conductivity

To understand the underlying mechanism of the enhanced ionic conductivity, atomistic simulations, and analysis were performed based on polymer electrolytes comprising polyphenylene sulfide (PPS), tetrafluoro-1,4-benzoquinone (TFBQ), lithium bis(trifluoromethane sulphone) imide (LiTFSI), and each of the compounds of formula (1), (2), (3), (4), and (5). The molecular dynamics simulations were conducted using the large atomic molecular massively parallel simulator (LAMMPS). The all-atom optimized potentials for liquid simulations (OPLS-AA) force field, which has been previously applied to polymer electrolyte systems, was utilized to describe the atomic interactions. Atomic partial charges were computed by fitting the molecular electrostatic potential at atomic centers from ORCA using the second-order Möller-Plesset perturbation (MP2) with a cc-pVTZ basis set. Due to the use of a non-polarizable force field, partial charges for ions were scaled by 0.8 to account for electronic screening and enhance predictions of interionic interactions.

The initial configurations were generated using a Monte Carlo algorithm implemented in the Enhanced Monte Carlo software. The equilibration process involved an energy minimization using the steepest descent method, followed by a 200-ps run in the NPT ensemble with a Berendsen barostat at a reference pressure of 1 atm and time steps of 2 fs. After equilibration, 100-ns long dynamics runs with the NVT ensemble at 350 K were performed for each cell. Throughout, a Nose-Hoover thermostat was utilized with a reference temperature of 350 K, and periodic boundary conditions were applied in all directions.

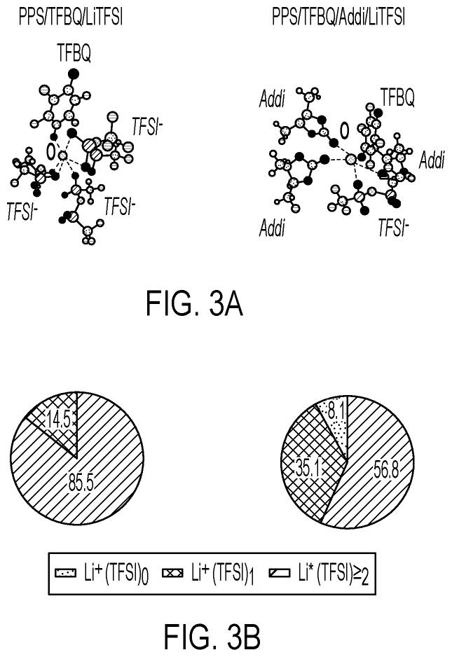

FIG. 3A shows the predicted solvation structures of the first Li+ solvation sheath from the atomistic molecular dynamic (MD) simulations. The coordinating oxygen on the solvents and anions is labeled. FIG. 3B illustrates the distribution of the solvent and anions within the Li⁺ solvent sheath categorized by whether there are 0, 1, or ≥2 TFSI-anions present, corresponding to fully dissociated Li⁺:(Li⁺(TFSI⁻)₀); Li+-anion single pairs: (Li⁺(TFSI⁻)₁); or Li+-anion cluster: (Li⁺(TFSI⁻)_{≥2}, in four electrolyte systems, PPS/TFBQ/LiTFSI, PPS/TFBQ/Addi/LiTFSI. The results of the molecular dynamic (MD) simulations indicate that the inclusion of the fluorinated sulfonamide compounds of the present disclosure in the polymer electrolyte matrix significantly reduces the aggregation of anions from 85.5% to 56.8% around the solvation sheath of Li⁺ ions. This phenomenon creates a more favorable environment for ion movement and contributes to the observed increase in ionic conductivity.

The improved rate performance of polymer electrolytes facilitated by the fluorinated sulfonamide compounds of the present disclosure added as an additive to a solid-state polymer electrolyte opens up opportunities for application in a wide range of electrochemical systems, including but not limited to electric vehicles, hybrid vehicles, and stationary energy storage systems, where high-rate performance is crucial for efficient energy utilization and improved overall device performance.

Further, the disclosure comprises additional notes and examples as described below.

Clause 1. A composition for a solid polymer electrolyte comprising an ion-conducting polymer matrix; a lithium salt; and an additive comprising at least one fluorinated sulfonamide compound selected from the group consisting of:

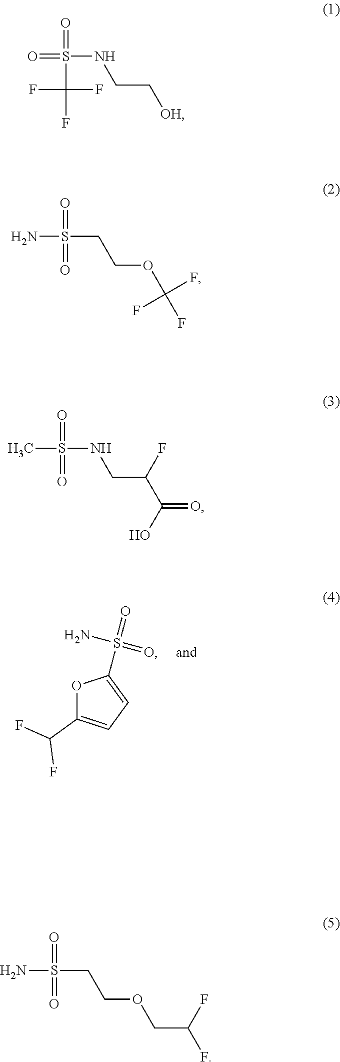

Clause 2. The composition according to clause 1, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC).

Clause 3. The composition according to clause 1, wherein the ion-conducting polymer matrix comprises a charge-transfer complex which comprises a polar aromatic ring.

Clause 4. The composition according to any one of clause 3, wherein the charge-transfer complex comprises a polyphenylene sulfide (PPS) matrix or a 6-dimethyl-p-phenylene sulfide (PMPS) matrix.

Clause 5. The composition according to clause 3 or 4, wherein the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ).

Clause 6. The composition according to any one of clauses 3 to 5, wherein the charge-transfer complex comprises HQ-BQ, Th-BQ, Px-BQ, Py-TCNQ, TTF-TCNQ, TTF-CL, or Ph-CLA.

Clause 7. The composition according to any one of clauses 1 to 6, wherein the lithium salt is bis(trifluoromethanesulfonyl)imide (LiTFSI).

Clause 8. A solid polymer electrolyte comprising polyphenylene sulfide (PPS), tetrafluoro-1,4-benzoquinone (TFBQ), lithium bis(trifluoromethane sulphone) imide (LiTFSI), and at least one additive selected from the group consisting of:

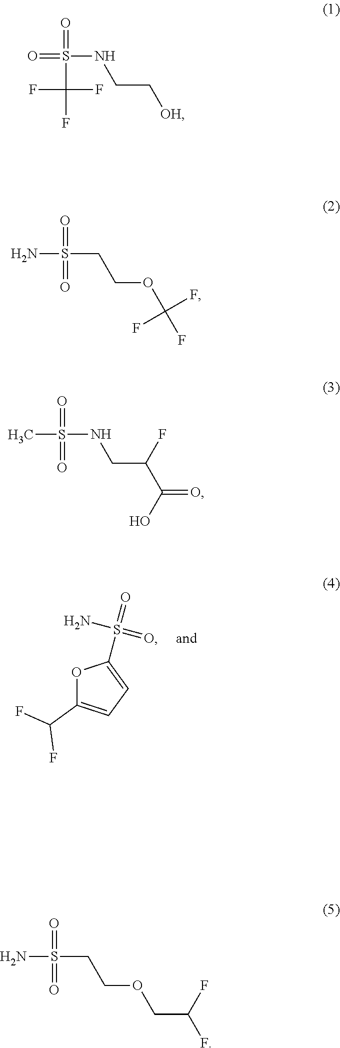

Clause 9. A solid polymer electrolyte comprising the composition according to any one of clauses 1 to 8.

Clause 10. A solid-state lithium-ion battery comprising: an anode; a cathode; a solid polymer electrolyte between the anode and cathode; an anode collector; and a cathode collector, wherein the polymer electrolyte comprises: an ion-conducting polymer matrix; a lithium salt; and an additive comprising at least one fluorinated sulfonamide compound selected from the group consisting of:

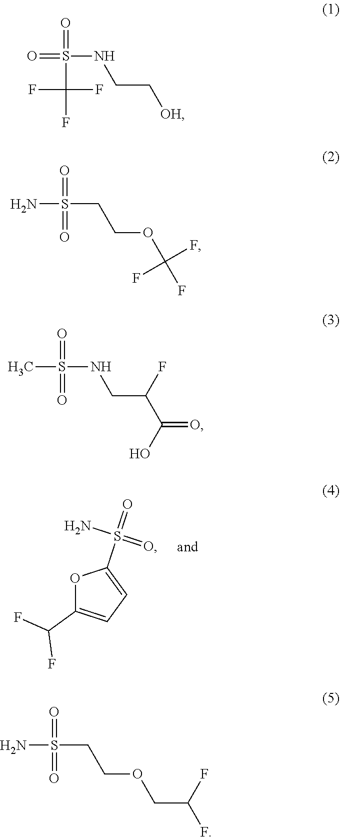

Clause 11. The solid-state lithium-ion battery according to clause 10, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC).

Clause 12. The solid-state lithium-ion battery according to clause 10, wherein the ion-conducting polymer matrix comprises a charge-transfer complex.

Clause 13. A method for enhancing ion conductivity of a solid polymer electrolyte, said method comprising: providing an ion-conducting polymer matrix and adding a lithium salt and an additive comprising at least one fluorinated sulfonamide compound selected from the group consisting of:

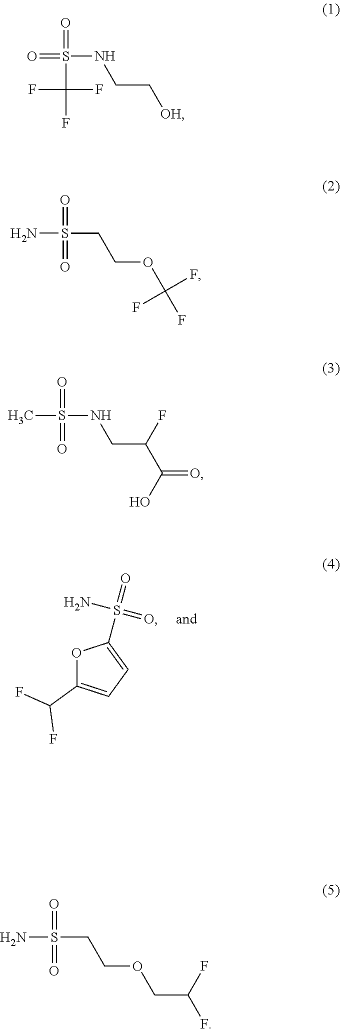

Clause 14. The method according to clause 13, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), and polypropyl carbonate (PPC).

Clause 15. The method according to clause 14, wherein the ion-conducting polymer matrix comprises a charge-transfer complex.

Clause 16. The method according to clause 14 or 15, wherein the charge-transfer complex comprises a polyphenylene sulfide (PPS) matrix or a 6-dimethyl-p-phenylene sulfide (PMPS) matrix.

Clause 17. The method according to any one of clauses 14 to 16, wherein the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ).

Clause 18. The method according to any one of clauses 14 to 17, wherein the charge-transfer complex comprises HQ-BQ, Th-BQ, Px-BQ, Py-TCNQ, TTF-TCNQ, TTF-CL, or Ph-CLA.

Clause 19. The method according to any one of claims 13 to 18, wherein the lithium salt is bis(trifluoromethanesulfonyl)imide (LiTFSI).

Clause 20. The method according to any one of clauses 14-19, wherein the charge conducting complex comprises polyphenylene sulfide (PPS) and an electron acceptor which comprises tetrafluoro-1,4-benzoquinone (TFBQ), and bis(trifluoromethanesulfonyl)imide (LiTFSI).

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A composition for a solid polymer electrolyte comprising
an ion-conducting polymer matrix;
a lithium salt; and
an additive comprising at least one fluorinated sulfonamide compound selected from the group consisting of:

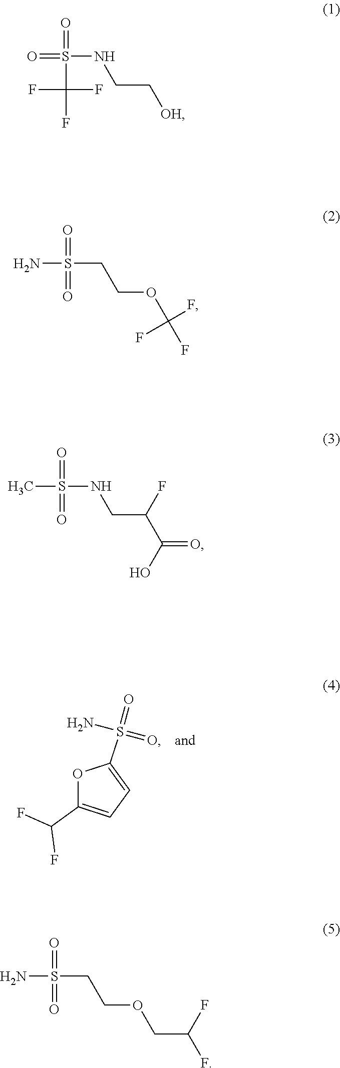

2. The composition according to claim 1, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC).

3. The composition according to claim 2, wherein the ion-conducting polymer matrix comprises a charge-transfer complex which comprises a polar aromatic ring.

4. The composition according to claim 3, wherein the charge-transfer complex comprises a polyphenylene sulfide (PPS) matrix or a 6-dimethyl-p-phenylene sulfide (PMPS) matrix.

5. The composition according to claim 4, wherein the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ).

6. The composition according to claim 5, wherein the charge-transfer complex comprises HQ-BQ, Th-BQ, Px-BQ, Py-TCNQ, TTF-TCNQ, TTF-CL, or Ph-CLA.

7. The composition according to claim 1, wherein the lithium salt is bis(trifluoromethanesulfonyl)imide (LiTFSI).

8. A solid polymer electrolyte comprising polyphenylene sulfide (PPS), tetrafluoro-1,4-benzoquinone (TFBQ), lithium bis(trifluoromethane sulphone) imide (LiTFSI), and at least one additive selected from the group consisting of:

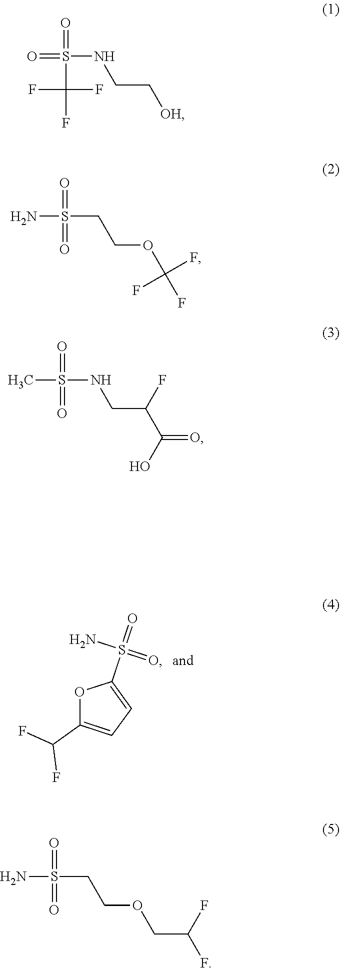

9. A solid polymer electrolyte comprising the composition according to claim 1.

10. A solid-state lithium-ion battery comprising:
an anode;
a cathode;
a solid polymer electrolyte between the anode and cathode;
an anode collector; and
a cathode collector,
wherein the polymer electrolyte comprises:
an ion-conducting polymer matrix;
a lithium salt; and
an additive comprising at least one fluorinated sulfonamide compound selected from the group consisting of:

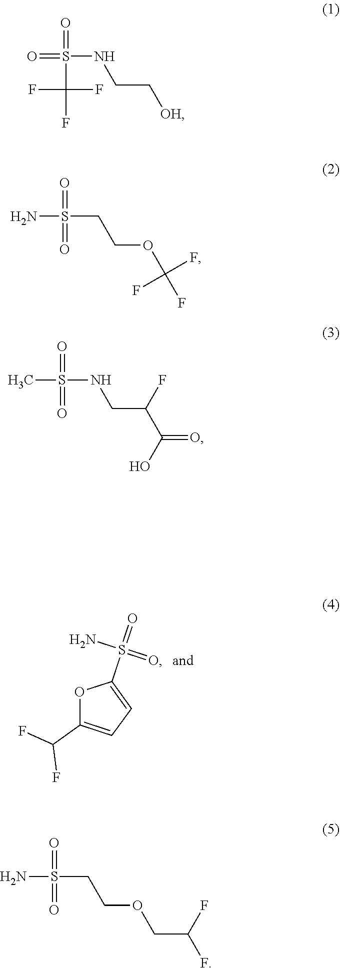

11. The solid-state lithium-ion battery according to claim 10, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), poly(ethylene carbonate) (PEC), and polypropyl carbonate (PPC).

12. The solid-state lithium-ion battery according to claim 10, wherein the ion-conducting polymer matrix comprises a charge-transfer complex.

13. A method for enhancing ion conductivity of a solid polymer electrolyte, said method comprising:
providing an ion-conducting polymer matrix and adding a lithium salt and an additive comprising at least one fluorinated sulfonamide compound selected from the group consisting of: 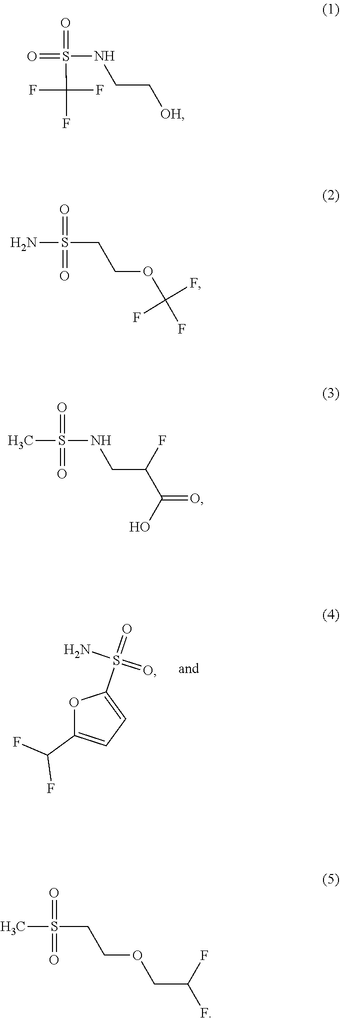
and

14. The method according to claim 13, wherein the ion-conducting polymer matrix comprises a polymer selected from the group consisting of polyethylene oxide (PEO), polyvinylidene fluoride (PVDF), polyacrylonitrile (PAN), polymethyl methacrylate (PMMA), polyethylene glycol (PEG), poly(formaldehyde) (POM), poly(vinylene carbonate) (PVC), and polypropyl carbonate (PPC).

15. The method according to claim 14, wherein the ion-conducting polymer matrix comprises a charge-transfer complex.

16. The method according to claim 15, wherein the charge-transfer complex comprises a polyphenylene sulfide (PPS) matrix or a 6-dimethyl-p-phenylene sulfide (PMPS) matrix.

17. The method according to claim 16, wherein the charge-transfer complex further comprises an electron donor selected from the group consisting of hydroxyquinone (HQ), tetrathiafulvalene (TTF), phenoxazine (Px), thianthrene (Th), and pyrene (Py) and/or an electron acceptor selected from the group consisting of benzoquinone (BQ), tetrafluoro benzoquinone (TFBQ), chloranil (CL), 7,7,8,8-tetracyanoquinodimethane (TCNQ), and 2,3-dichloro-5,6-dicyano-p-benzoquinone (DDQ).

18. The method according to claim 17, wherein the charge-transfer complex comprises HQ-BQ, Th-BQ, Px-BQ, Py-TCNQ, TTF-TCNQ, TTF-CL, or Ph-CLA.

19. The method according to claim 14, wherein the lithium salt is bis(trifluoromethanesulfonyl)imide (LiTFSI).

20. The method according to claim 17, wherein the charge conducting complex comprises polyphenylene sulfide (PPS) and an electron acceptor which comprises tetrafluoro-1,4-benzoquinone (TFBQ), and bis(trifluoromethanesulfonyl)imide (LiTFSI).
